(19) United States
(12) Patent Application Publication
(10) Pub. No.: US 2010/0288080 A1
(43) Pub. Date: Nov. 18, 2010

(54) BOTTLE OPENING DEVICE AND METHOD FOR MAKING SAME

(76) Inventor: Alexis Babusiaux, Binche (BE)

Correspondence Address: JAMES C. WRAY, 1493 CHAIN BRIDGE ROAD, SUITE 300, MCLEAN, VA, 22101, US

(21) Appl. No.: 12/450,197

(22) PCT Filed: Mar. 17, 2008
(86) PCT No.: PCT/BE2008/000018

§ 371 Date: May 14, 2010

(30) Foreign Application Priority Data
Mar. 15, 2007 (BE) 2007/0112

(51) Int. Cl. B67B 7/14; B21K 23/00

(52) U.S. Cl. 81/3.4; 76/101.1

(57) ABSTRACT

Tool for opening bottles closed by caps, forming a bottle opener (16), capable of being actuated by a single hand, including means for automatically holding said cap (12) after opening and comprising at least one bottle opening push-off area (14), enabling, by pushing off on the cap itself, the necessary force to be exerted in order to remove the cap from the bottle by deforming said cap slightly. The above tool is remarkable in that it comprises at least one separation push-off area (10) pushing off on the flank of the bottle, enabling, after opening the bottle by pushing off on same, the top of the tool to be moved away so as to enable the contents of the bottle to be poured without being disturbed by the tool or by the cap.

Manufacturing process for a variant of the bottle opener thereto.

### FIELD OF THE INVENTION

The present invention lies in the field of tools for opening bottles closed by crown caps or capsules, tools commonly known as bottle openers.

This type of device is a tool commonly used by individuals, in the kitchen or at the table, but also for the service in bars and restaurants, where it is very useful to uncap bottles with one hand, leaving the other hand free for other functions.

Moreover, when one uncaps a bottle, it is very convenient when the opener automatically retains the cap. Thus one needs not hold the cap in hand while using the bottle opener, which facilitates the use of the bottle opener and allows a more hygienic operation. Indeed, it is difficult to avoid touching the neck of the bottle when the cap must be taken in hand while it is still in place. It could also happen that the cap drops at random on the table or the floor, and so it can arrive at an unwanted place.

In general, the bottle openers in the prior art utilize a bottle opening push-off area. The push-off area may be located on top of the cap, or more often on the side opposite the tearing of the cap. This push-off area will be hereinafter referred to as the “ bottle opening push-off area”.

The present invention therefore lies in the field of bottle openers that can be operated with one hand, including a means for automatically maintaining said cap after opening and having at least one bottle opening push-off area enabling, by pushing-off on the cap itself, the necessary force to be exerted in order to remove the cap from the bottle by deforming said cap slightly.

### STATE OF THE ART

We know from the document U.S. Pat. No. 2,155,947 a bottle opener that can be operated with one hand, with a beveled claw used as a means of grasping the cap containing on the side opposite the beveled claw an elastic branch allowing on one hand to hold the cap in the tool after removal from the bottle, on the other hand to allow said beveled claw to well apply under the cap, and still be able to escape the neck of the bottle and avoid stick or break the neck of the bottle.

This known opener shows several drawbacks: once the cap removed from the bottle, said cap is retained in the tool, and one would immediately pour the content of the bottle into a glass. But in doing so, the flow of beverage strikes against the cap and the tool, which does not allow pouring cleanly and is not very hygienic. One is thus obliged to withdraw the tool, set down the bottle or use his other hand before making the service to customers or guests.

Moreover, this bottle opener is difficult to use. As it is of linear form and thin, it must first be placed on the bottle by hand. Moreover, it must be held well once removed from the bottle, otherwise it may fall. Moreover, the hold of the cap by spring creates an unstable equilibrium, in that a small gap causes the ejection of the capsule, which is not desirable as long as it is not returned to the kitchen. Finally, the thumb alone must exert the whole uncapping effort, all other fingers are clinging the bottle.

The document GB2 062 592 presents a slightly different solution but with similar disadvantages. FIG. 3 of this document shows that the tool is operated by the thumb, other fingers are clinging the neck of the bottle. In addition, the tool must first be placed on the bottle, and then the hand must change places to operate the tool. Finally, once opened, it is impossible to pour the content directly, because the tool must first be removed by grasping it with the hand before the content can be poured.

The document DE 296 14 152 has a comparable solution, but again, it is impossible to pour the content directly after opening, you must first remove the bottle opener, seizing him by the hand before you can pour the content. Moreover, this opener does not hold the cap after opening.

The document EP 1 172 328 describes a bottle opener comprising a ring to make it possible to hold it with a finger. But the cap is not hold once removed and can fall anywhere. Furthermore, the hand must come very close to the neck of the bottle, which does not guarantee a perfectly hygienic operation.

### SUMMARY OF THE INVENTION

The aim of this invention is to solve all these various drawbacks while offering a bottle opener that can be operated with one hand, easy to use, and particularly to make the service immediately after the bottle is uncapped without the need to place the bottle or to interfere with the other hand.

To resolve this problem, the bottle opener object of the invention comprises at least one separation push-off area pushing off on the flank of the bottle, enabling, after opening the bottle by pushing off on same, the top of the tool to be moved away in continuation of the same gesture, so as to enable the contents of the bottle to be poured without being disturbed by the head of the tool or by the cap.

An embodiment of the invention to obtain this separation push-off area is to achieve first a substantially flat head containing a claw, which can be beveled, for the tearing off of the cap and designed to be positioned on the cap, secondly a substantially planar handle, the searched push-off area being positioned near the end of the handle closest to the head, and thirdly a connector, which can be curved, for example S-shaped, which connects the head to the handle so that the head and the handle form an obtuse angle between them and that the extension of the plane formed by the handle cuts the head near the claw. This way, when the handle is applied to the substantially vertical face of the lower part of the bottle, the beveled claw is substantially in the vertical continuation of the handle, and therefore separated from the neck. The cap is then completely removed from the neck, the beveled claw being on the side of the cap that separates last from the neck.

In the bottle opener of the invention, the expression “near the claw” must be understood as the condition for obtaining the full effect of separation of the cap from the neck. Thus, if the plane formed by the handle meets the head in a remote area of the beveled claw towards the connector between the head and the handle, the cap will be insufficiently distant from the neck and in this case that condition is not met. However, if the plane formed by the handle meets the head in a remote area of the beveled claw towards the free end of the head, or even does not meet the head because the plane passes beyond the free end of the head, the cap will be more separated from the neck, and said condition will be met, and such a bottle opener is part of the present invention.

In a preferred embodiment of the device according to the invention, the push-off area can also be materialized by an added stud on the connector near the handle.

The cap is hold, once the bottle is open, by a holding means.

A magnetized element or a magnet may for example form this holding means.

To facilitate the use of the bottle opener according to the invention, and in particular to hold it easily between two uses, it has a gripping means to hold the tool without grasping it.

According to an advantageous embodiment of the invention, the gripping means may be a ring to hold the tool with a finger without having to grasp it.

In a specific embodiment of the invention, such a ring can advantageously be obtained from a cut in the handle.

According to an alternative embodiment of the invention, the gripping means may consist in several rings.

According to another embodiment of the invention still, such a ring may be replaced by a strap.

In a specific embodiment of the invention, such a strap may be elastic.

According to another alternative embodiment of the tool according to the invention, its gripping means comprises one or more T-shaped pieces whose base is attached to the handle of the tool, enabling also to hold the tool in hand.

The bottle opener object of the invention allows, in one single gesture and with one hand to grasp the bottle, open it, hold the cap, pour the content, set down the bottle, and get rid of the cap where and when needed.

Thus the other hand remains free for other tasks, in particular to hold a glass or a plate. The barman can serve all the guests, the tool and the cap remaining attached to the bottle, but sufficiently removed so as not to impede the pouring of the drink. He can then return to the kitchen where he will drop the cap by a simple push of the thumb in a bin provided for this purpose.

The bottle opener object of the invention can be used interchangeably by right-handed or left-handed people, and can even be used by people who lost the use of one hand.

Use of the opener object of the invention is also facilitated by the fact that the four fingers exert effort on the tool, and that the thumb is used only as a support on the other side of the bottle.

Another advantage of this invention lies in the fact that at no time the barman's hand comes into contact with the cap, the neck of the bottle, or even the part of the bottle opener that comes in contact with the cap or neck. Thus, the conditions of use of the bottle opener of the invention are particularly hygienic.

According to a preferred embodiment of the invention, the bottle opener has at least one leaf having a certain elasticity, which is intended to rest on the side of the cap on the side diametrically opposite to the tearing claw.

This leaf may, through its elasticity, at the same time provide a means for holding the cap.

Preferably said leaf consists in a thin sheet spring or spiral spring.

In particular it may be constituted by a thin sheet spring attached to an added plot on the connector near the handle.

Said leaf may also be formed by a cutting in the connector, said cutting starting at the junction between the head and the connector, extending down to the beginning of the handle, forming a first leaf and then back to the head forming said leaf with a certain elasticity.

A further advantage of the invention lies in the fact that the bottle opener of the invention can operate for crown caps or capsules with slightly variable sizes. Indeed the opening push-off area of the elastic leaf on the edge of the cap opposite the side of the claw adjusts automatically along the tool according to the size of the cap to be removed, a little lower for the larger caps, and a little higher for smaller caps. The opener of the invention thus has a universality feature.

The invention also relates to a manufacturing process for a bottle opener.

The bottle opener presented according to the present invention can be manufactured in one piece, for example from one stamped metal sheet or from cast metal. In this case, the manufacturing process includes an initial step of stamping of a metal plate, then cutting of the outer contour, of a half-moon with a claw and an edge at one end, of leaves in its middle section, and of a band in order to make a ring at the other end.

The following operations can be performed in any order, ie the bending of said ring, the beveling of the claw and finally the bending to get at the side of the half-moon a substantially flat head, at the opposite side a substantially plane handle, and between them, a connector in form of curve counter-curve, S-shaped, so that the head and the handle form between them an obtuse angle, and that the extension of the plane formed by the handle cuts the head near the claw, the leaves being excluded from the bending and their ends being introduced in their cutting in the area of the connector during the bending of the latter.

However, it can also be manufactured from several pieces of metal or synthetic cast, welded or glued materials. It can also be produced by a combination of plastics and metal, or cast metal or cast or injected synthetic material. It can still be made of wood or combination of wood with metal, synthetic material or both. It can be covered and decorated with synthetic materials, plastics, metal, latex, rubber and be painted or treated, all to give it a different, modern, attractive, playful or professional aspect.

Other advantages of the present invention will become apparent in light of the description of some preferred embodiments of the device of the invention, which are illustrated with the accompanying drawings.

### BRIEF DESCRIPTION OF DRAWINGS

FIG. 1 shows a first embodiment of a bottle opener according to the invention, in a perspective view.

FIG. 2 shows the bottle opener shown in FIG. 1 but seen from a different side.

FIG. 3 shows the bottle opener shown in FIG. 1 but seen from a third side yet.

FIGS. 4 to 6 are views similar to views 1 to 3 but of an alternative bottle opener according to a second embodiment of the invention.

FIGS. 7 to 14 represent each of the eight stages of use of the bottle opener of the invention.

The 15 to 18 represent each of the four detailed steps of uncapping itself with a bottle opener according to the invention.

The same references in the figures generally refer to identical or similar elements.

### DESCRIPTION

Generally, the present invention relates to a device of the bottle-opener type for opening bottles generally closed by a cap or another similar closure means such as a crown cork.

The bottle opener 16 shown in FIG. 1 has a flat head 4 having a semicircular opening. An advantageously beveled claw 1 for easily gripping the underside of the cap is provided in the middle of the curved part of the semicircle. The straight part of the semicircle constitutes an edge 3 which enables the tool to be placed easily on the bottle. This edge 3 is one possible bottle-opening bearing zone, as can be seen in FIGS. 16 and 17.

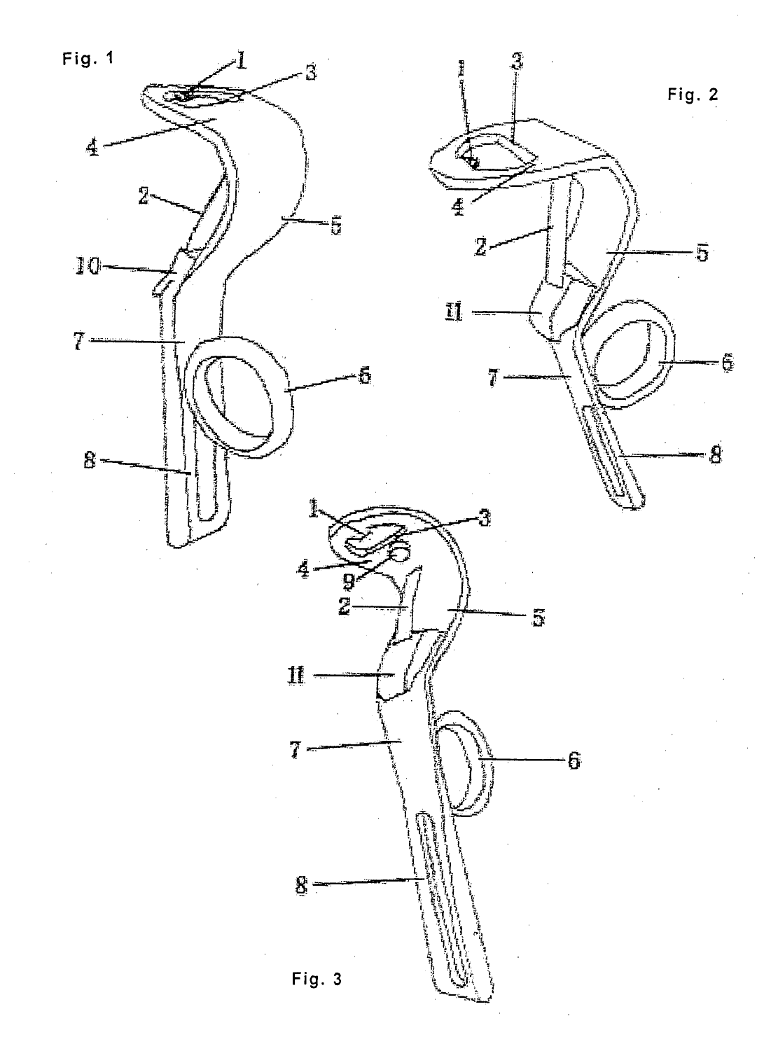

FIGS. 2 and 3 show two different views of the same bottle opener 16 as the one shown in FIG. 1.

A small magnet 9 is arranged under the head 4 and is intended to hold on to the cap once the bottle has been opened. This magnet may also constitute a bottle-opening bearing zone, as can be seen in FIGS. 16 and 17.

The bottle opener 16 also has a flat handle 7 whose primary function is to act as a lever arm for increasing the force applied by the fingers at the cap.

It also has a connector 5 which links the head 4 to the handle 7 in the form of a reverse curve enabling the handle 7 to be positioned such that continuing the handle 7 would intersect the head 4 close to the beveled claw 1. In this way, when the bottle has been opened and the handle 7 is held against the side of the bottle, it is ensured that the cap has been completely removed sideways with respect to the neck of the bottle, as can be seen in FIG. 10.

In order to reinforce the latter feature, a stud 11 is connected to the connector 5 close to the handle 7. This stud serves as a zone 10 bearing on the side of the bottle when, once the bottle has been opened, it is desired to move the cap away from the neck of the bottle. It is the removal bearing zone 10/separation push-off area (10).

When this bearing zone comes into contact with the bottle, impacts and noise may occur. In a preferred version of the invention, this stud is covered with a piece of soft material in order to damp the impacts and noise on the bottle. This may be a small piece of rubber.

The stud 11 also serves for fastening a spring leaf 2. This leaf 2 bears against the edge of the cap while the bottle is being opened and represents another bottle-opening bearing zone, as can be seen in FIGS. 8 and 9, for detaching the cap from the neck.

The resilient nature of this leaf 2 has a double function. Firstly, it keeps the claw 1 held under the cap and prevents it coming away from the cap without the bottle being opened. Secondly, it allows this same claw 1 to come away from the neck pulling the cap with it and thus prevents the neck from being trapped or broken.

A ring 6 is arranged on the rear of the handle 7 and can be connected thereto by adhesive bonding or welding. However, it can also be bent out of a cutout made in the handle 6. This cutout can then serve in particular for hooking the tool on a wall hook or belt.

The ring 6 makes it easier to hold the tool. Specifically, a finger such as the index finger or middle finger is slid into the ring and the tool can then be positioned very easily. There is no need to grasp it, or actually hold it.

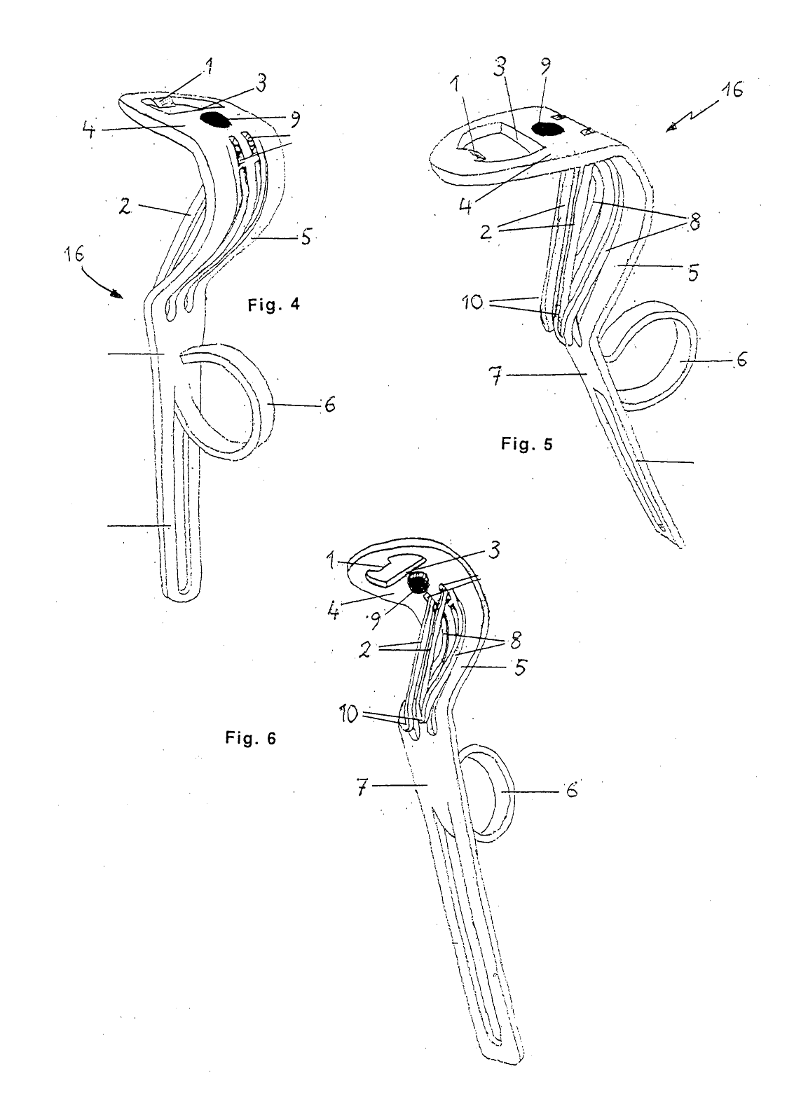

The bottle opener shown in FIG. 4 is an alternative embodiment according to the invention. It comprises in a similar manner a flat head 4 having a semicircular opening. An advantageously beveled claw 1 for easily gripping the underside of the cap is provided in the middle of the curved part of the semicircle. The straight part of the semicircle constitutes an edge 3 which enables the tool to be placed easily on the bottle. This edge 3 is one possible bottle-opening bearing zone, as can be seen in FIGS. 16 and 17.

FIGS. 5 and 6 show two different views of the same bottle opener as the one shown in FIG. 4.

A small magnet 9 is arranged in or under the head 4 and is intended to hold on to the cap once the bottle has been opened. This magnet may also constitute a bottle-opening bearing zone, as can be seen in FIGS. 16 and 17.

The bottle opener 16 also has a flat handle 7 whose primary function is to act as a lever arm for decreasing the force applied by the fingers at the cap.

It also has a connector 5 which links the head 4 to the handle 7, which are thus secured rigidly together, in the form of a reverse curve, or S bend, enabling the handle 7 to be positioned such that continuing the handle 7 would intersect the head 4 close to the beveled claw 1. In this way, when the bottle has been opened and the handle 7 is held against the side of the bottle, the cap has been completely removed sideways with respect to the neck of the bottle, as can be seen in FIG. 10.

Two pieces 8 and 2 are cut out of the connector 5 of the bottle opener 16. The base of the cutout is located at the junction between the head 4 and the connector 5. The cutout runs down as far as the start of the handle 7, forming 8, and then runs back up as far as the start of the head 4, forming 2. This type of cutout gives the arms 2 a certain resilience.

The connection between the arms 2 and 8 constitutes the removal bearing zones 10.

In a preferred version of the invention, these zones are covered with pieces of soft material in order to damp the impacts and noise on the bottle. These may be small pieces of rubber.

Said arms 2 bear against the edge of the cap while the bottle is being opened and represent another bottle-opening bearing zone, as can be seen in FIGS. 8 and 9, for detaching the cap from the neck.

The resilient nature of these arms 2 has a double function. Firstly, it keeps the claw 1 held under the cap and prevents it coming away from the cap without the bottle having been opened. Secondly, it allows this same claw 1 to come away from the neck pulling the cap with it and thus prevents the neck from being trapped or broken.

A ring 6 is arranged on the rear of the handle 7 and can be connected thereto by adhesive bonding or welding, for example.

A cutout can be made in the handle 7. This cutout can then serve in particular for hooking the tool on a wall hook or the belt.

The ring 6 makes it easy to hold the tool. Specifically, a finger such as the index finger or middle finger is slid into the ring and the tool can then be positioned very easily. There is no need to grasp it, or actually hold it.

The magnet 9 may have different forms. It may be embedded or visible by being arranged below or above the head 4 and it may be connected by adhesive bonding, for example. It is also possible for the entire tool or part thereof to be magnetized, thereby avoiding the use of an additional component as magnet.

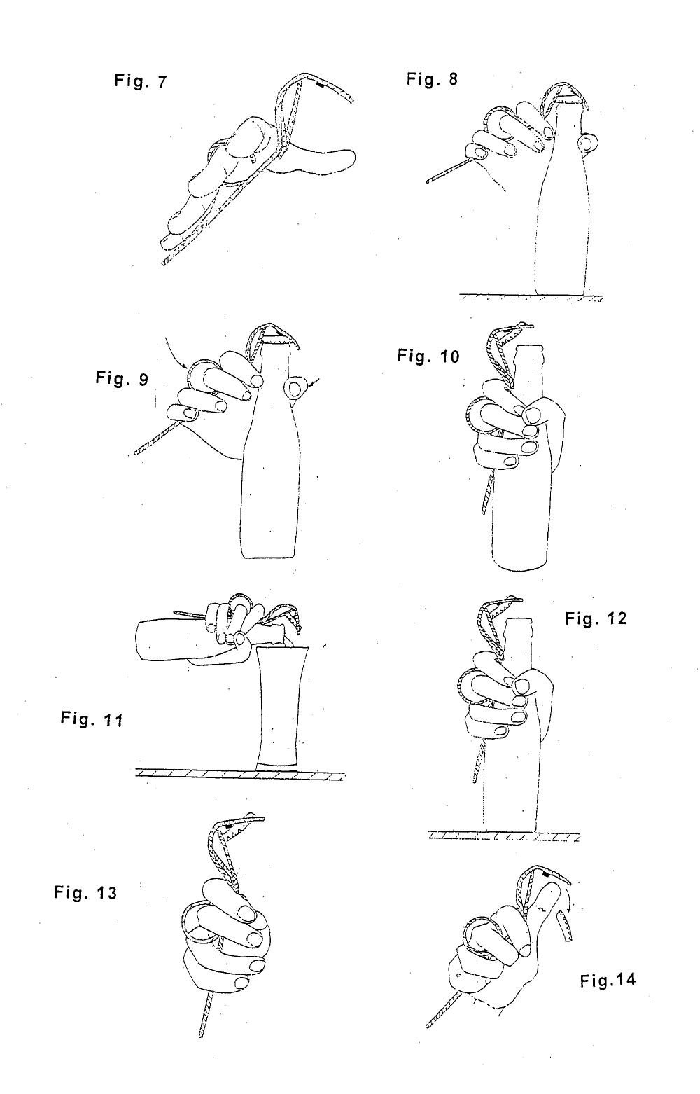

The way the tool according to the invention functions is described hereinbelow with regard to its use in eight steps with reference to FIGS. 7 to 14. These eight steps can be carried out quickly and easily without the tool leaving the hand.

FIG. 7 shows how the bottle opener is held on the hand by way of its ring. There is absolutely no need to grasp it firmly with the fingers. This system works for any size of fingers and hand.

FIG. 8 shows how the tool is positioned on the bottle. The first part in engagement is the claw 1 located in the half-moon formed in the head of the bottle opener, which, due to its beveled form, hooks very easily on the underside of the cap. While the tool is being placed on the bottle, the flat side 3 located in the same half-moon forces the tool to be positioned optimally with respect to the cap and the arms 2 are positioned naturally on the upper side of the cap opposite the location of engagement of the claw 1. The lower edge of the magnet 9 is in contact with the cap while the flat side 3 of the half-moon remains at a slight distance from the cap. While positioning the tool, the user places his thumb on the neck of the bottle and begins to apply pressure with his other fingers. At this moment the cap is trapped between the claw 1 and the arm 2. The bottle can then be lifted due to the force exerted by the thumb on the neck and by the other fingers on the handle 7 of the tool.

FIG. 9 shows how, by continuing to exert two forces in opposite directions, one exerted by the thumb on the neck and the other by the other fingers on the handle 7 of the tool, the operation enables the free flexible arm 2 to move back resiliently toward the bottle opener. Firstly, the magnet 9, which was in contact with the cap during positioning, warps the top of the cap slightly and enables the flat side 3 of the half-moon to come into contact with the cap and thereby form a bottle-opening bearing zone, the handle 7 forming the corresponding lever arm. The resultant force exerted by this lever arm by way of the bearing zone 3 is impressed under the cap at the location of engagement of the claw 1, thereby obliging the cap, by deforming slightly, to be released from the bottle. Next, the bearing zone between the arm 2 and the upper side of the cap, opposite the location of engagement of the claw 1, takes over as the additional bottle-opening bearing zone, enabling the cap to be removed from the bottle.

FIG. 10 shows how, once the bottle has been opened, the handle 7 of the bottle opener is located naturally against the bottle and the head 4 of the tool keeps the cap well away from the neck by virtue of its magnet 9. The cap does not have to touch the magnet to be held by the magnetic field.

FIG. 11 shows at what point it is easy to pour the contents of the bottle into a container without having to move the hand.

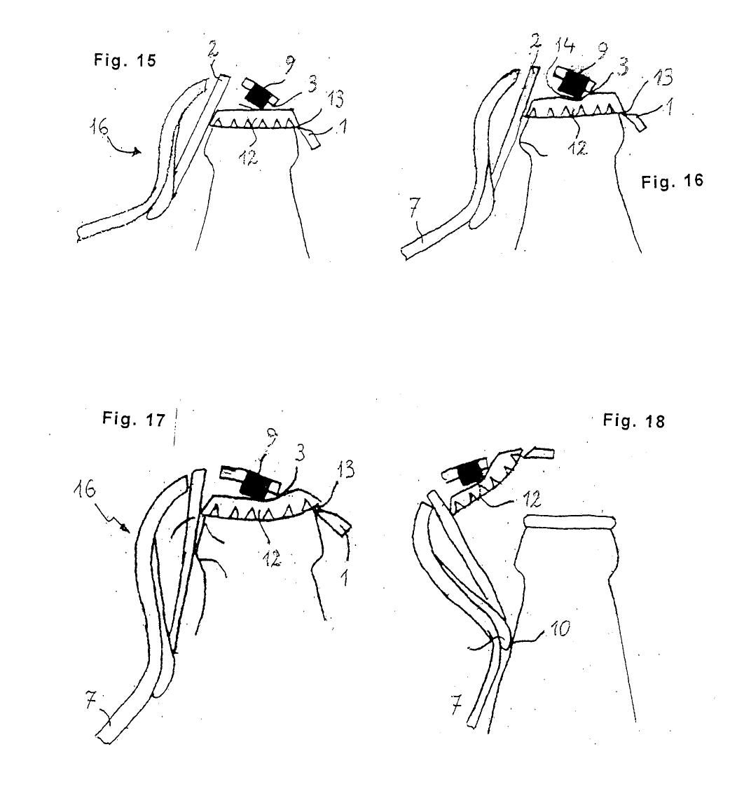

Following completion of this operation, FIG. 12 shows that all that remains is to put the bottle down. FIG. 13 shows that once the bottle has been put down it is not necessary to hold the tool since it remains hooked on the hand. It can be seen in FIG. 14 how it is easy to use the thumb to force the cap off the bottle opener and allow it to fall into a box, trash can or any other container provided for that purpose. Throughout the process, the other hand has remained perfectly free. It could be used, in particular, to hold a plate or to serve the glasses. The process may be started again immediately without the tool leaving the hand.

A more detailed description of the opening phase will be given hereinbelow.

FIGS. 15 to 18 show the detailed bottle-opening phases in four successive representations.

FIG. 15 shows that at the end of the tool positioning phase the claw 1 grips the cap 12 at the point 13, while on the other side, the flexible arm 2 bears against the edge of the cap 12. This forces the bottle opener 16 to remain in position during the opening phase, the magnet 9 being in contact with the upper part of the cap 12 at the point 14. The flat side 3 of the half-moon is not in contact at that moment with the cap 12.

FIG. 16 shows the next part of the movement. If the thumb is pressed against the neck and the other fingers are pressed on the handle 7, the flexible arm 2 has to move resiliently back slightly. The magnet 9, bearing on the top of the cap at the point 14, warps the top of the cap slightly, thereby making subsequent cap removal easier. At that moment, the flat side 3 of the half-moon located in the head of the bottle opener 16 comes into contact with the cap 12.

FIG. 17 shows the next part of the movement. By continuing to exert two opposing forces, one with the thumb on the neck and the other with the other fingers on the handle 7, the flexible arm 2 is then again forced to move resiliently back slightly while forcing the claw 1 and the flat side 3 of the half-moon to remain in position on the cap. Given that the flat side 3 of the half-moon forms a bearing zone on the top of the cap 12 and that the resultant force is impressed under the cap at the location 13 of engagement of the claw 1, continuing the movement started forces the cap to leave the bottle by deforming slightly.

FIG. 18 shows how, once the bottle has been opened, with the handle 7 against the body of the bottle, the removal bearing zone 10 forces the top of the tool to move away from the bottle in order to leave the neck of the bottle free. The cap is held by the magnetic field of the magnet.

The primary role of the magnet 9 in the present invention is to hold the cap 12 once the bottle has been opened. However, it has another function during the opening phase, as can be seen in FIGS. 16 and 17, namely that of slightly warping the top of the cap before opening the bottle. This function greatly aids bottle opening. However, the bottle opener 16 could function without this magnet, for example when all or part of the bottle opener is magnetized in order to hold the cap while the magnet could be replaced in its function of slightly deforming the cap before opening the bottle by a small metal peg cut out of the material of the tool or a component attached to the bottle opener by adhesive bonding, welding or any other means.

1-25. (canceled)

26. Tool for opening bottles closed with caps, forming a bottle opener (16), capable of being actuated by a single hand, including means for automatically holding said cap (12) after opening and comprising at least one bottle opening push-off area (14), enabling, by pushing off on the cap itself, the necessary force to be exerted in order to remove the cap from the bottle by deforming said cap slightly, wherein it comprises at least one separation push-off area (10) pushing off on the flank of the bottle, enabling, after opening the bottle by pushing off on same, the top of the tool to be moved away, and wherein the tool comprises a means of immobilizing the top of the tool in its separated position, so as to enable the contents of the bottle to be poured without being disturbed by the tool or by the cap.

27. Tool according to claim 26, wherein the tool comprises a substantially flat head (4) containing a claw (1) for the tearing off of the cap and designed to be positioned on the cap, further comprising a substantially planar handle (7), each separation push-off area (10) being positioned near the end of the handle (7) closest to the head (4), and further comprising a connector (5) which connects the head (4) to the handle (7) so that the head (4) and the handle (7) form an obtuse angle between them and that the extension of the plane formed by the handle (7) cuts the head (4) near the claw (1).

28. Tool according to claim 27, wherein the connector (5) is curved.

29. Tool according to claim 28, wherein the connector (5) has an S-shaped curve.

30. Tool according to claim 29, wherein the claw (1) is bevelled.

31. Tool according to claim 29, wherein each separation push-off area (10) is arranged on a stud (11) added on said connector (5) near said handle (7).

32. Tool according to claim 31, wherein a piece of soft material is added on the tool near each separation push-off area (10).

33. Tool according to claim 29, wherein the tool comprises a magnetized element.

34. Tool according to claim 33, wherein the magnetized element is a magnet (9).

35. Tool according to claim 29, wherein the tool comprises a gripping means (6) allowing holding the tool without grasping it.

36. Tool according to claim 35, wherein the gripping means is chosen from a list consisting of at least one ring (6), a strap, preferably elastic, and at least one T-shaped piece with its base attached to the handle (7) of the tool.

37. Tool according to claim 29, wherein the tool comprises at least one leaf (2) having a certain elasticity, which is intended to push off on the side of the cap on the side diametrically opposite to the tearing claw (1).

38. Tool according to claim 37, wherein said leaf (2) forms a bottle opening push-off area.

39. Tool according to claim 38, wherein said leaf (2) is arranged so as to retain said cap automatically after opening.

40. Tool according to claim 37, wherein said leaf (2) is formed by a cutting in the connector (5), said cutting starting at the junction between the head (4) and the connector (5), extending down to the first end of the handle (7), forming a branch (8) and then back to the head (4) forming the leaf (2).

41. Tool according to claim 37, wherein the leaf (2) is chosen from a list consisting of a thin sheet spring, a spiral spring, and a thin sheet spring attached to an added plot on the connector (5) near the handle (7).

42. Tool according to claim 37, wherein the bottle opening push-off area on the side of the cap extends along the leaf (2), a part of this zone becoming active according to the size of the cap to be removed, giving said tool a universality feature.

43. Manufacturing process for a bottle opener (16), comprising the following steps:
a stamping of an elongated plate, with cutting of the outer contour, a half-moon at one end comprising a claw (1) and an edge (3), and leaf (2) and branch (8) in its middle section, and
a bending in order to get on the half-moon side a head (4) substantially flat, on the opposite side a handle (7) substantially plane, and between them, a connector (5) in form of curve counter-curve, S-shaped, so that the head (4) and the handle (7) form between them an obtuse angle, and the extension of the plane formed by the handle (7) cuts the head (4) near the claw (1), the leaves (2) being excluded from the bending and their ends being introduced in their cutting in the area of the connector (5) during the bending of the latter.

44. Manufacturing process according to claim 43, wherein the process comprises an operation of cutting into the handle (7) and a bending process of this cut to get a ring (6).

45. Use of a device according to claim 1 for the opening of bottles closed with crown caps.
